(19) United States
(12) Patent Application Publication
(10) Pub. No.: US 2010/0081461 A1
(43) Pub. Date: Apr. 1, 2010

(54) SMS Based Social Networking

(75) Inventors: Ajay K. Bothra, Hyderabad (IN); Vinod Anantharaman, Issaquah, WA (US); Niranjan S. Nayak, Hyderabad (IN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/243,551

(22) Filed: Oct. 1, 2008

(51) Int. Cl. H04W 4/12

(52) U.S. Cl. 455/466; 709/206

(57) ABSTRACT

Methods for retrieving and transmitting data associated with a social network of an entity through short message service (SMS) protocol are disclosed herein. A system for transmitting the data through SMS protocol is also disclosed. In one embodiment, input is transmitted through SMS from a cellular telephone to a database, data related to the input is retrieved from the database, and the retrieved data is transmitted through SMS protocol to the cellular telephone. The transmitted data may be presented to a user as a representation on the cellular telephone, for example. The representation may comprise a profile of the entity and/or a profile of another entity associated with the entity's social network, for example.

### BACKGROUND

In some emerging markets personal computer penetration is relatively low, especially when compared to the penetration of cellular telephones. In India, for example, around ten million homes have personal computers, whereas the cellular telephone industry is booming with an installed base of nearly three hundred million phones and another eight million new phones being sold per month.

Additionally, in the United States and throughout the world, social networking applications, particularly online applications, are becoming a powerful phenomenon. Social networking applications are popular for a variety of reasons. For instance, social networks offer the benefit of maintaining “loose connections” with several tens or even hundreds of people who were in a user's life at one time or another. Users may also use social networks to find classmates, friends, and co-workers that the user has lost touch with over the years.

Increasingly, social network applications are being developed to operate on cellular telephones (to capture markets where personal computer penetration is low and/or to provide users with the freedom to view their social networks anywhere). These applications, most of which are modifications of web-based social networking applications, use a data connection (e.g., general packet radio service (GPRS)) to transport data (e.g., graphics, images, text, etc.) to the cellular telephone. While most cellular telephones are equipped to provide a data connection, service providers typically require users to purchase a monthly data plan before the data connection is activated. In many parts of the world, these data plans are expensive, causing cellular telephone-based social networking to be unavailable for many cellular telephone users.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

According to a first aspect, a method of presenting one or more representations of a social network of an entity to a user is presented. The method comprises retrieving data associated with the social network of the entity (e.g., the user, an organization managed by the user, etc.). This data may comprise data related to: a profile of the entity; a profile of another entity associated with the social network; correspondence with the entity; entities that user may want to add to the entity's social network; etc. The method also comprises transmitting the retrieved data through a short message service (SMS) protocol to a device compatible with SMS technology (e.g., a cellular telephone, personal digital assistant, etc.) and presenting the transmitted data as one or more representations of the social network of the entity to the user on the device.

According to another aspect, a system for transmitting data related to a social network of an entity is presented. The system comprises a transmission component configured to receive SMS data (e.g., data capable of being transmitted through SMS protocol) relating to the social network of the entity that is sent by a SMS compatible device. The transmission component is also configured to send SMS data related to the social network of the entity to the device. The system also comprises a main service that is in operable communication with the transmission component and configured to retrieve data from a database based upon received input. The main service is also configured to transfer the retrieved data to the transmission component.

In many areas, it cost consumers (significantly) less to purchase a SMS subscription than it does to purchase subscriptions for other data transfer services, such as general packet radio service (GPRS). In India, for example, cellular telephone service providers charge approximately seventy-five cents per month for unlimited SMS while other data transfer techniques, such as GPRS, costs approximately fifteen dollars a month for unlimited service. While the amount of data that is capable of being transmitted through SMS protocol is less (relative to an amount transferrable through general packet radio service (GPRS) and other data transfer techniques), data transfer through SMS protocol provides a way for users without personal computers and/or data plans on their cellular telephones, for example, to create and maintain social networks.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of presenting one or more representations of a social network of an entity to a user.

FIG. 2 is an exemplary illustration of a representation of data that may be presented to a user if the user wants to create and/or modify an entity's profile.

FIG. 3 is an exemplary illustration of a second representation of data that may be presented to a user if the user wants to create and/or modify a profile.

FIG. 4 is an exemplary illustration of a representation of data that may be presented as a home screen of an entity.

FIG. 5 is an exemplary illustration of a representation of data that may be presented to a user if the user wants to change a status message.

FIG. 6 is an exemplary illustration of a representation of data that may be presented as a message broad of an entity.

FIG. 7 is an exemplary illustration of a representation of data that may be presented to a user if the user wants to view entities associated with a social network.

FIG. 8 is an exemplary illustration of a representation of data that may be presented as a home page of an entity.

FIG. 9 is a component block diagram illustrating an exemplary system for transmitting data related to a social network of an entity.

FIG. 10 is an illustration of an exemplary computer-readable medium comprising processor-executable instructions configured to embody one or more of the provisions set forth herein.

FIG. 11 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

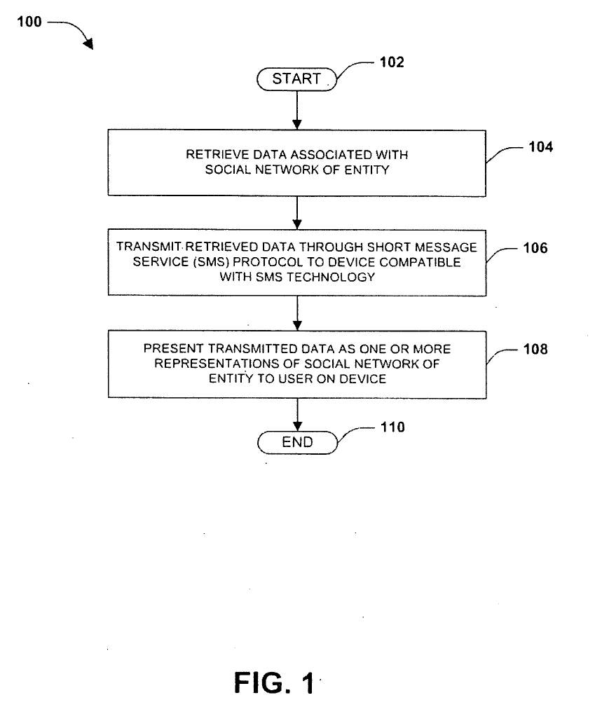

Turning initially to FIG. 1, an exemplary methodology 100 is illustrated for presenting one or more representations of a social network of an entity to a user. “Social network” is used in a board sense herein to comprise a set of entities that interact and exchange information in a social relationship. Entities include, for example, people (e.g., the user and/or other users), groups, organizations, and/or countries, while social relationships refer to friendship, employment, and/or other relationships between these entities. The representation(s) may depict an entity's profile, an entity's status message, and/or messages to the entity from other entities, for example. It may also depict information about entities desiring to be part of the social network and/or search results regarding other entities that use a social network application similar to that used by the user, for example. The data may be presented to the user on a cellular telephone and/or another device compatible with short message service (SMS) technology.

At 102, the method begins, and data associated with the social network of the entity is retrieved at 104. The retrieved data may comprise data related to a profile of the entity, a profile of another entity associated with the social network, recent updates that have been made to profiles of one or more entities, and/or messages sent to the entity by other entities, for example. In one example, data is retrieved as a function of one or more characters used to conduct a query of a database, and the data that is retrieved is more relevant (relative to other data associated with the entity's social network) based upon the characters used to conduct the query (e.g., a change in the characters may cause a change in the relevancy of data). The characters used to conduct the query may be a function of user input and/or an automated input technique (that inputs a set of terms periodically), for example.

In one embodiment, data is retrieved when one or more characters are transmitted through SMS protocol from a cellular telephone operated by the user. For example, the user may select to view a private message sent to the entity (e.g., the user or an organization the user is managing), and characters indicative of the selection may be sent through SMS protocol to an apparatus that conducts a query of the database, based upon the characters, and retrieves the private message. It will be appreciated that the user may be unaware of the characters sent to the apparatus that conducts a query of the database. For example, the characters may be part of a backend mechanism that causes a particular set of data to be retrieved from the database.

In another embodiment, data is retrieved periodically as a function of an automated script that inputs a search term and causes data relevant to the search term to be retrieved. For example, the user may designate that data associated with more recent events in the entity's social network be retrieved daily at 2 p.m., and the automated script may retrieve and/or cause to be retrieved the user designated data. That is, a query of the entity's social network may be conducted daily (without receiving daily input from the user), and data related to more recent events (e.g., profile changes, upcoming birthdays, new messages, etc.) may be retrieved from a database that stores data regarding the entity's social network. It will be understood to those skilled in the art that other techniques for retrieving data are also contemplated.

At 106, the retrieved data is transmitted through SMS protocol to a device compatible with SMS technology (e.g., a cellular telephone, personal digital assistant, etc.). It will be appreciated that if the retrieved data is not in a format compatible with SMS protocol, the data may be reformatted so that it is capable of being transmitted through SMS. The retrieved data may be tagged with an identification tag associated with the device (e.g., cellular telephone number) so that the transmitted data is detected by the device and not detected by other devices. Additionally, the retrieved data may be targeted to a particular port (used by a social network application) on the device.

At 108, the transmitted data is presented as one or more representations of the social network of the entity to the user on the device. The representation(s) may depict a profile of the entity (e.g., the user or organization managed by the user), a profile of another entity, and/or one or more messages sent to the user, for example. It will be appreciated that less than all of the representation(s) may be presented on the device as a function of the available screen space, and the user may scroll down, for example, to view additional portions of the representation(s). It will also be appreciated that the representation(s) may comprise less than all of the relevant data (because of SMS protocol limitations), and the data presented in the representation may be more relevant data. For example, the user may select to view other entities associated with the entity's social network and data related to the entities may be retrieved from a database, transmitted through SMS protocol to the device, and presented to the user as a representation. If less than all the data is able to be transmitted because of SMS protocol limitations a first set of data (e.g., data related to entities with last names that begin with the letter “a”) may be transmitted and presented as a first representation, for example. The user may select a “next” button, for example, and a second set of data (e.g., data related to entities with last names that begin with the letter “b”) may be transmitted and presented as a second representation, for example.

Data that has been reformatted for transmission using SMS protocol may be arranged once it is received by the device. For example, the data may be reformatted so that is it transmitted through multiple SMS transactions (because of character limitations in SMS protocol), and the data may be arranged once it is received by the device. It will be appreciated that the device may arrange the data into one or more representations. It will also be appreciated that the number of representations do not need to correspond to SMS transmissions. For example, data from two or more SMS transmissions may be presented to the user as one representation and/or data from one SMS transmission may be presented to the user as two or more representations.

In one embodiment, the transmitted data is arranged by an application (e.g., J2ME application, BREW application, etc.) on the device prior to being presented to the user. The application may, for example, arrange the data in such a way that a rich user interface is created from the data. It will be appreciated that the application may also provide a platform for presenting the transmitted data to the user.

In one embodiment, the presented representation(s) is capable of receiving user input. For example, the user may input text (through a keypad on the device) and/or select terms, symbols, etc. presented in the representation. In one example, the user input may be used to create a profile of the entity, modify the profile of the entity, communicate with one or more other entities, and/or modify the entities associated with the entity's social network, for example, based upon the representation(s) presented. The user input may also cause a second representation of the entity's social network to be presented to the user. For example, if the user is viewing a private message sent to the entity (e.g., the user, an organization managed by the user. etc.), the user may select to respond to the message, and a second representation (with a character entry field for responding to the private message) may be presented to the user.

It will be understood to those skilled in the art that the received user input (e.g., the selection, text, etc.) may be transmitted from the device to the database through SMS protocol and used to retrieve data that is more relevant as a function of the user input. The more relevant data may be transmitted from the database to the device through SMS protocol and presented to the user as the second representation, for example. It will be appreciated that subsequent representations may be presented to the user as a function of addition user input. It will also be appreciated the previously presented representations may be presented again. In one example, a predetermined number (based upon the memory capabilities of the device) of previously viewed representations are stored on the device so that they may be retrieved more quickly (relative to retrieving, transmitting, and presenting the data again).

It will also be understood to those skilled in the art that the data transmitted to the database may also be forward to n number of devices associated with other entities. For example, the user may designate that an inputted message be sent to five entities associated with the entity's social network and the database (or another apparatus) may forward the message to the designated entities. The method 100 ends at 110.

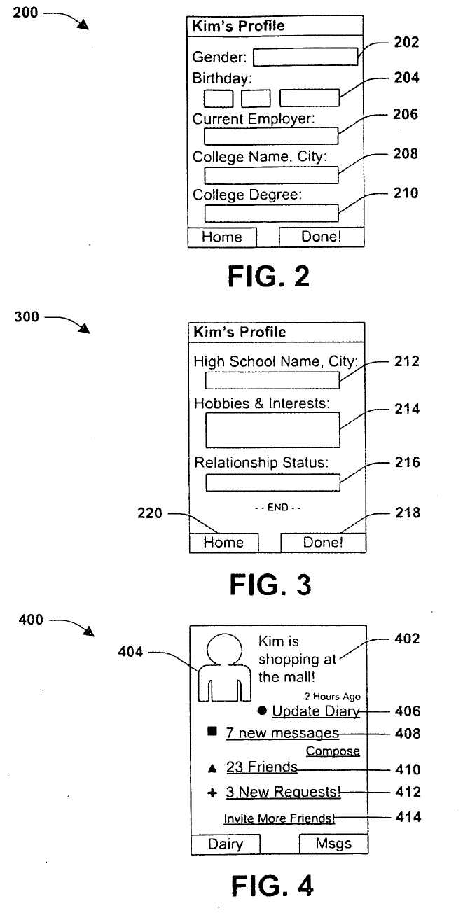

By way of illustration, FIGS. 2-8 illustrate exemplary examples of representations of transmitted data. These representations may be presented to the user on a cellular telephone and/or another device compatible with SMS technology. It will be appreciated that FIGS. 2-8 are intended to exemplify some types of representations that may be presented to the user and are not intended to limit the scope of the representations that are possible and/or limit the types of content comprising the entity's social network.

FIG. 2 illustrates a representation 200 that may be presented to the user if the user wants to create and/or modify a profile of the entity (e.g., a profile of the user or an organization managed by the user). The representation 200 may comprise a field for inputting the entity's gender 202, the entity's birthday 204, the entity's current employer 206, the entity's college 208, and/or the entity's college degree 210, for example. It will be appreciated that previously entered data about the entity's profile may be presented in one or more of the fields 202, 204, 206, 208, and 210 if the entity's profile was previously created.

In one embodiment, a representation similar to that illustrated in FIG. 2 may be used to create a profile of the entity if the entity has not previously created a profile and/or constructed a social network. For example, the entity may register to use a social network application, and a representation similar to that illustrated in FIG. 2 may be presented to the user. Once the user has inputted data about the entity into the representation, the data may be transmitted through SMS protocol to the database. The database may create a file, for example, to store data related to the entity. Additional data may then be transmitted to the device so that the user may construct a social network for the entity by selecting entities associated with the entity. In one example, a user constructs the social network by creating a profile and adding entities associated with entity to the social network. The user may add one or more new entities to the social network by selecting the new entities from a contact list (e.g., address book) on the device, selecting the new entities from a search of entities using an application similar to an application used by the entity (e.g., a social network application), and/or inputting identification tags (e.g., cellular telephone number) of the new entities. Data about the user's selections may then be transmitted to the database and stored in the file to construct a social network of entities.

FIG. 3 illustrates a second representation 300 that may be presented to the user if a portion of the transmitted data is unable to be presented in the representation 200 (illustrated in FIG. 2). That is, the second representation 300 may be a continuation of the data presented in representation 200 (in FIG. 2). In one example, the user may view the second representation 300 by scrolling down (using a d-pad on a cellular telephone) when the representation 200 is presented. The second representation 300 may comprise fields (in addition to those illustrated in representation 200) for inputting data used to create and/or modify the entity's profile. In the illustrated example, the second representation 300 comprises fields for inputting the entity's high school 212, the entity's hobbies 214, and the entity's relationship status 216. It will be appreciated that the second representation 300 may also comprise one or more fields presented in the representation 200 (illustrated in FIG. 2). For example, the field for inputting the entity's college degree 210 may be presented to the user in both the representation 200 and the second representation 300.

In one embodiment, the data is presented to the user in two representations (e.g., representation 200 and second representation 300) as a function of the screen space available for presenting the data to the user. For example, the available screen space on a cellular telephone may be less than the available screen space on a desktop computer monitor, so less data may be presented in a representation on the cellular telephone than in a representation on the desktop computer monitor. Therefore, while the transmitted data may be presented as one representation on the desktop computer monitor, it may be presented as two or more representations on the cellular telephone, for example.

Data inputted into one or more fields of the representation 200 and/or the second representation 300 may be transmitted, through SMS protocol, from the device to a database that stores the data when a “done” button 218 is selected. Additionally, predetermined data may be transmitted to the device and presented to the user as another representation (e.g., a home screen) when a “home” button 220 is selected. It will be appreciated that some the data presented to the user may not be transmitted to the device through SMS protocol. For example, some data (e.g., standard entry fields, data that changes infrequently, data that is accessed more frequently, etc.) may be stored on the device and recalled from the device (rather than from a server that transmits the data to the device through SMS) when a predetermined event occurs (e.g., a particular button is selected, an application is opened, etc.).

FIG. 4 illustrates an exemplary representation 400 of (predetermined) data that may be presented to the user when the user logs onto the entity's social network and/or selects to return to a home screen (e.g., by selecting the “home” button 220 as illustrated in FIG. 3), for example. The home screen may provide the user with an overview of the entity's social network, provide a brief summary of recent events that have occurred in the entity's social network, and/or act as a central point from which the user may easily navigate through various aspects of the entity's social network (e.g., messages, requests to be part of the social network, etc.). The representation 400 may comprise a status message 402 of the entity, and/or an avatar 404 representative of the entity. The representation 400 may also comprise links (for updating a diary 406, viewing messages 408, viewing friends 410 (e.g., entities associated with the entity's social network), accepting friends 412 into the entity's social network, and/or or inviting friends 414 to join the entity's social network) that cause data related to different aspects of the entity's social network to be retrieved from the database, transmitted to the device, and presented as another representation.

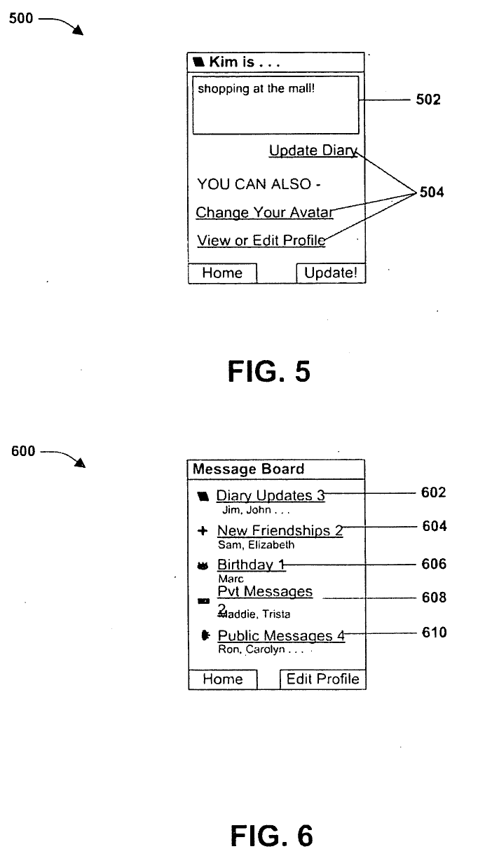

FIG. 5 illustrates an exemplary representation 500 of data that may be presented when a user selects to update a status message of the entity. The entity's status message may indicate what the entity is presently doing, for example. In the illustrated example, the representation 500 comprises a field for updating the status message 502 and links 504 that may be selected by the user (causing data related to the selected link to be retrieved, transmitted, and presented as another representation to the user).

FIG. 6 illustrates an exemplary representation 600 of data relating to a message board that is configured to present the user with data related to more recent events in the entity's social network. In the illustrated example, the representation comprises links to data regarding entities that have recently updated their profiles 602, new requests 604 to be included in the entity's social network, upcoming birthdays 606 of entities associated with the entity's social network, private messages 608 sent to the entity, and public messages 610 (viewable by other entities) sent to the entity.

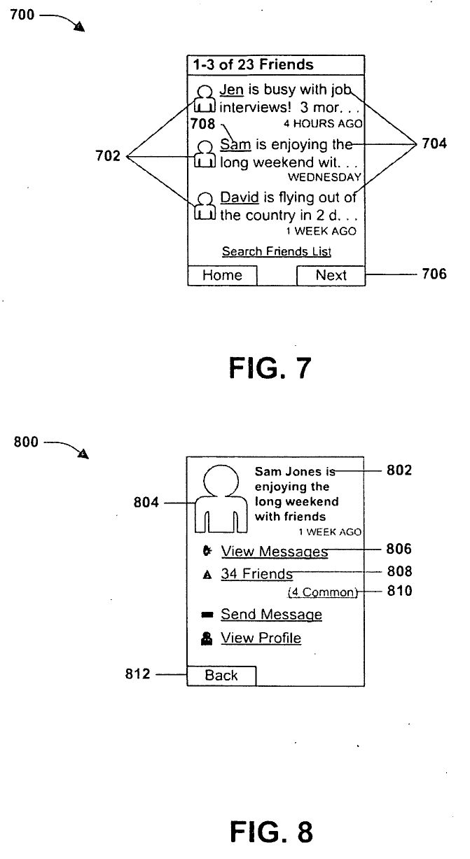

FIG. 7 illustrates an exemplary representation 700 of data relating to entities associated with the entity's social network. The representation 700 may comprise avatars 702 and status messages 704 of other entities associated with the social network. It will be appreciated that the entities may be ranked according to some criteria. For example, the entities may be ranked alphabetically and/or ranked according to how recently their status messages were changed. In the illustrated example, less than all of the data related to status messages and avatars of entities associated with the social network is capable of being presented in one representation (because of SMS protocol limitations and/or screen space limitations), and the representation 700 comprises a first set of transmitted data. The first set may comprise higher ranked entities, for example. A second set of data (related to status messages and avatars of entities that are ranked lower than the entities in the first set of transmitted data but higher than other entities associated with the entity's social network) may be retrieved and presented as another representation when a “next” button 706 is selected, for example. In the illustrated example, an entity's name (e.g., Sam 708) is link. If the user selects the entity (e.g., Sam 708), data related to the selected entity's profile (e.g., Sam's home page) may be transmitted to the device and presented as a representation.

FIG. 8 illustrates an exemplary representation 800 of data associated with the profile of another entity (e.g., Sam) in the entity's social network. That is, representation 800 depicts what may be presented to the user if the user selects to view Sam's home page (in representation 700). The illustrated representation 800 comprises a status message 802 that Sam has created and an avatar 804 associated with Sam. The representation 800 also comprises a link to public messages 806 sent to Sam, a link to entities associated with Sam's social network 808, a link to entities associated with both Sam's and the entity's (e.g., the user, an organization managed by the user, etc.) social networks 810. In the illustrated example, a previously presented representation (e.g., representation 700 of FIG. 7) is presented to the user if the user selects the “back” button 812. In another example, previously presented representations are presented when the user selects the right arrow button on a d-pad (on a cellular telephone).

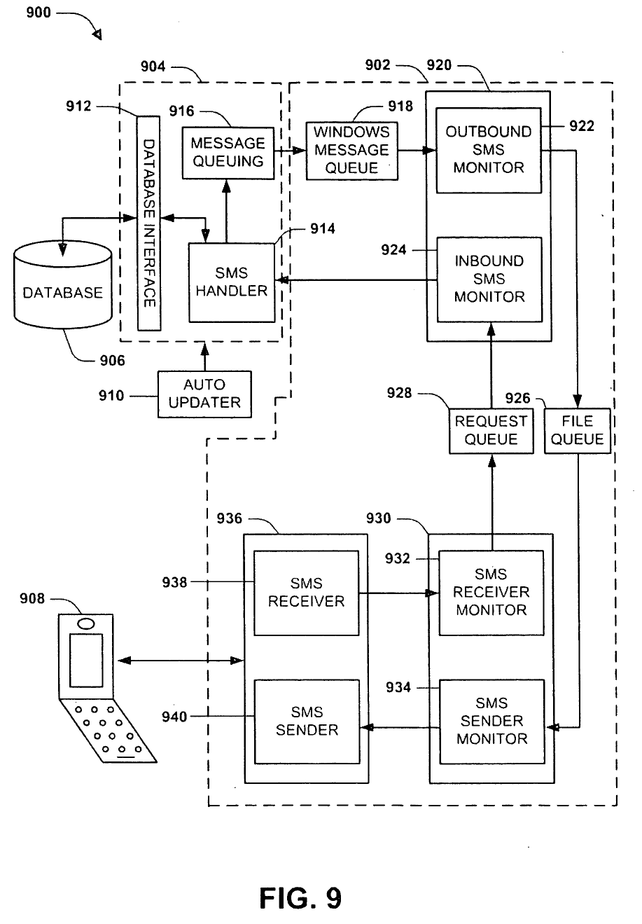

FIG. 9 illustrates an exemplary system 900 for transmitting data related to a social network of an entity. The system 900 comprises a transmission component 902 configured to receive short message service (SMS) data, relating to the social network of the entity, that is sent by a SMS compatible device 908 (e.g., a cellular telephone). The transmission component 902 is also configured to send SMS data, related to the social network of the entity, to the device 908. The system 900 also comprises a main service 904 that is in operable communication with the transmission component 902 and configured to retrieve data from a database 906 based upon received input. The main service is also configured to transfer the retrieved data to the transmission component 902.

It will be appreciated that here, as elsewhere in this disclosure, “database” is used to refer to a store of data, and not to a particular computer system, software, architecture, schema, format, etc. for holding such information. The database may also comprise a plurality of replicated databases configured to store the same data for redundancy and improved performance in access, a plurality of databases configured to store different sets of data or different portions of a set of data and/or any other type of data storage mechanism (e.g., not necessarily limited to databases).

The main service 904 may be a web service, for example, which interacts with the database 906 and processes input (e.g., SMS requests). The input may be received from the transmission component 902 and/or from an auto updater 910 that is configured to send request (e.g., make requests) for data periodically. For example, the auto updater may send requests to the main service 904 every hour, and the request may cause the main service 904 to check for updates (associated with the entity's social network) in the database 906.

In one embodiment, the main service 904 is divided into components that are responsible for various tasks of the main service 904. For example, the main service 904 may comprise a database interface 912 that is configured to pull data from the database 906 (based upon queries of the database 906 using SMS requests) and/or push data (received from the transmission component 902) into the database 906. The main service may also comprise an SMS handler 914, for example, which is configured to receive input from the transmission component 902 and/or the auto updater 910 and issue commands as a function of the received input. For example, the SMS handler 914 may order the database interface 912 to retrieve data from the database 906. The main service 904 may also comprise a message queuing component 916 configured to send data (intended for the device 908) from the main service 904 to the transmission component 902. In one example, the SMS handler 914 instructs the message queuing component 916 what data to send to the transmission component 902. For example, the SMS handler 914 may receive the retrieved data from the database interface 912 and instruct the message queuing component 916 to send the retrieved data to the transmission component 902. The SMS handler 914 may also instruct the message queuing component 916 to send data received from the transmission component 902 back to the transmission component with instructions to forward it to devices associated with other entities (e.g., providing a communication channel between the entity and other entities associated with the entity's social network).

The transmission component 902 is configured to transmit data between the main service 904 and the device 908. In one embodiment, the transmission component 902 comprises other components that facilitate the transmission of data and/or allow the transmission component 902 to be scalable (e.g., transmit data to and/or from n number of SMS compatible devices). For example, the transmission component 902 may comprise a windows message queue 918 configured to store the data transmitted from the main service 904 to the transmission component 902.

The transmission component 902 may also comprise a message queue monitor 920. The message queue monitor 920 may be configured to create a file for the data from the database 902 and/or convert a request file from the device 908 into a request for the main service 902. In one example, the message queue monitor 920 comprises two components an outbound SMS monitor 922 (configured to pull data from the windows message queue 918, create a file that may be sent through SMS protocol, and push it into a file queue 926) and an inbound SMS monitor 924 (configured to pull data from a request queue 928 and process the request file into a request for the SMS handler 914).

The transmission component 902 may also comprise a SMS send/receive console 930 configured to monitor for request files received from the device 908 and/or monitor for files ready to be sent to the device 908. In one example, the SMS send/receive console 934 comprises two components, a SMS receiver monitor 932 (configured to (continuously) check for incoming request files and push received request files to the request queue 928) and a SMS sender monitor 934 (configured to monitor for files that have been stored in the file queue 926 and push them to a component of the transmission component 902 that sends the file to the device 908).

In one example, an SMS gateway 936 is the component of the transmission component 902 that sends SMS data to the device 908. The SMS gateway 936 may also receive SMS data from the device 908. The SMS gateway 936 may be comprised of two components, for example, a SMS receiver 938 (configured to receive SMS data from the device 908 and create a request file that may be pulled by the SMS receiver monitor 932) and a SMS sender 940 (configured to convert files pushed from the SMS sender monitor 934 to SMS data and push the SMS data to the device 908).

It will be appreciated that the SMS data may be transmitted through several intermediaries before reaching the device 908. For example, the device 908 may be a cellular telephone and a mobile provider network may receive the signal from the transmission component 902 and push it to the device 908. Representations of the data transmitted to the device 908 may be presented to a user on the device 908.

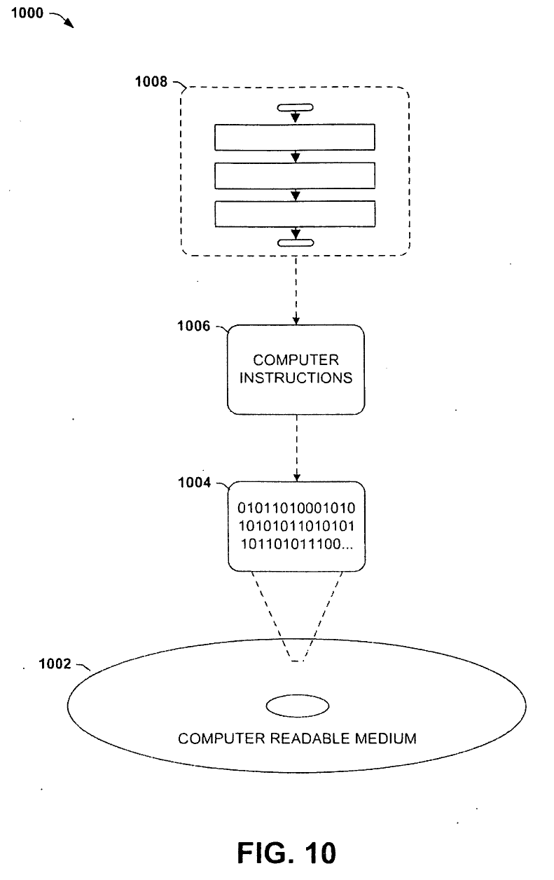

Still another embodiment involves a computer-readable medium comprising processor-executable instructions configured to implement one or more of the techniques presented herein. An exemplary computer-readable medium that may be devised in these ways is illustrated in FIG. 10, wherein the implementation 1000 comprises a computer-readable medium 1002 (e.g., a CD-R, DVD-R, or a platter of a hard disk drive), on which is encoded computer-readable data 1004. This computer-readable data 1004 in turn comprises a set of computer instructions 1006 configured to operate according to one or more of the principles set forth herein. In one such embodiment 1000, the processor-executable instructions 1006 may be configured to perform a method, such as the exemplary method 100 of FIG. 1, for example. In another such embodiment, the processor-executable instructions 1006 may be configured to implement a system, such as the exemplary system 900 of FIG. 9, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

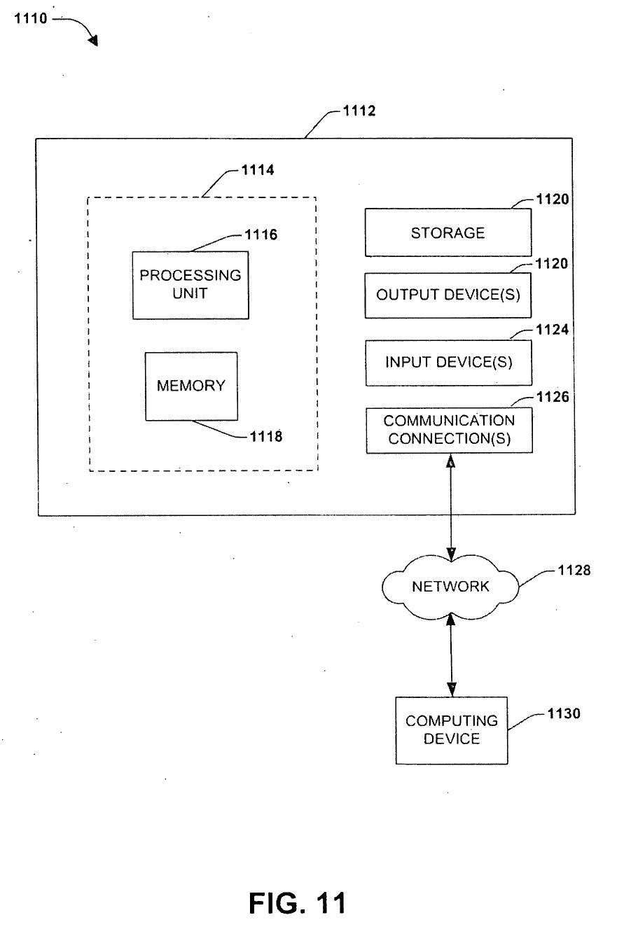

FIG. 11 and the following discussion provide a brief, general description of a suitable computing environment to implement embodiments of one or more of the provisions set forth herein. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system 1110 comprising a computing device 1112 configured to implement one or more embodiments provided herein. In one configuration, computing device 1112 includes at least one processing unit 1116 and memory 1118. Depending on the exact configuration and type of computing device, memory 1118 may be volatile (such as RAM, for example), non-volatile (such as ROM, flash memory, etc., for example) or some combination of the two. This configuration is illustrated in FIG. 11 by dashed line 1114.

In other embodiments, device 1112 may include additional features and/or functionality. For example, device 1112 may also include additional storage (e.g., removable and/or non-removable) including, but not limited to, magnetic storage, optical storage, and the like. Such additional storage is illustrated in FIG. 11 by storage 1120. In one embodiment, computer readable instructions to implement one or more embodiments provided herein may be in storage 1120. Storage 1120 may also store other computer readable instructions to implement an operating system, an application program, and the like. Computer readable instructions may be loaded in memory 1118 for execution by processing unit 1116, for example.

The term “computer readable media” as used herein includes computer storage media. Computer storage media includes volatile and nonvolatile, removable and non-removable media implemented in any method or technology for storage of information such as computer readable instructions or other data. Memory 1118 and storage 1120 are examples of computer storage media. Computer storage media includes, but is not limited to RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1112. Any such computer storage media may be part of device 1112.

Device 1112 may also include communication connection(s) 1126 that allows device 1112 to communicate with other devices. Communication connection(s) 1126 may include, but is not limited to, a modem, a Network Interface Card (NIC), an integrated network interface, a radio frequency transmitter/receiver, an infrared port, a USB connection, or other interfaces for connecting computing device 1112 to other computing devices. Communication connection(s) 1126 may include a wired connection or a wireless connection. Communication connection(s) 1126 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1112 may include input device(s) 1124 such as keyboard, mouse, pen, voice input device, touch input device, infrared cameras, video input devices, and/or any other input device. Output device(s) 1122 such as one or more displays, speakers, printers, and/or any other output device may also be included in device 1112. Input device(s) 1124 and output device(s) 1122 may be connected to device 1112 via a wired connection, wireless connection, or any combination thereof. In one embodiment, an input device or an output device from another computing device may be used as input device(s) 1124 or output device(s) 1122 for computing device 1112.

Components of computing device 1112 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1112 may be interconnected by a network. For example, memory 1118 may be comprised of multiple physical memory units located in different physical locations interconnected by a network.

Those skilled in the art will realize that storage devices utilized to store computer readable instructions may be distributed across a network. For example, a computing device 1130 accessible via network 1128 may store computer readable instructions to implement one or more embodiments provided herein. Computing device 1112 may access computing device 1130 and download a part or all of the computer readable instructions for execution. Alternatively, computing device 1112 may download pieces of the computer readable instructions, as needed, or some instructions may be executed at computing device 1112 and some at computing device 1130.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of presenting one or more representations of a social network of an entity to a user, comprising:
retrieving data associated with the social network of the entity;
transmitting the retrieved data through a short message service (SMS) protocol to a device compatible with SMS technology; and
presenting the transmitted data as one or more representations of the social network of the entity to the user on the device.

2. The method of claim 1, where data is retrieved at regular intervals.

3. The method of claim 1, comprising receiving SMS data from the device compatible with SMS technology.

4. The method of claim 3, where the retrieved data is a function of the received SMS data.

5. The method of claim 3, where the received data is data related to a social network profile of one or more entities.

6. The method of claim 3, comprising creating a profile of the user as a function of the SMS data received from the device.

7. The method of claim 6, comprising updating the profile of the user when supplemental SMS data associated with the profile is received.

8. The method of claim 3, comprising constructing a social network of the user based upon the SMS data received from the device.

9. The method of claim 8, comprising adding a new entity to the social network of the entity as a function of at least one of the following: the user selecting the new entity from a contact list on the device, the user selecting the new entity from a search of entities that use an application similar to the entity's, and the user inputting an identification tag of the new entity.

10. The method of claim 3, comprising sending the received SMS data to n number of entities.

11. The method of claim 1, where the retrieved data relates to a social network profile of one or more entities.

12. The method of claim 1, where the transmitted data is presented on the cellular telephone as a function of an application that operates on a cellular telephone.

13. The method of claim 12, the application automatically launched when data transmitted through SMS is received by the device.

14. A system for transmitting data related to a social network of an entity, comprising:
a transmission component configured to receive short message service (SMS) data relating to the social network of the entity that is sent by a SMS compatible device and configured to send SMS data related to the social network of the entity to the device; and
a main service that is in operable communication with the transmission component and configured to retrieve data from a database based upon received input and configured to transfer the retrieved data to the transmission component.

15. The system of claim 14, comprising an auto updater configured to notify the main service to retrieve data from the database at predetermined intervals.

16. The system of claim 14, where the transmission component comprises a queue configured to store SMS data when the transmission component is not able to communicate with the SMS compatible device.

17. The system of claim 14, where the main service is configured to arrange and store the SMS data received by the transmission component.

18. The system of claim 14, where the main service conducts a query of the database and retrieves data relevant to SMS data received by the transmission component from the device.

19. The system of claim 14, where the main service is configured to provide a communication channel between n number of entities.

20. A method of presenting one or more representations of a social network of an entity to a user, comprising:
receiving input from a device compatible with short message service (SMS) technology, where the input is used to conduct a query of one or more databases that store data related to the entity's social network;
retrieving data associated with the social network of the entity as a function of the received input;
transmitting the retrieved data through a SMS protocol to the device; and
presenting the transmitted data as one or more representations of the social network of the entity to the user on the device, where a social network application on the device functions as a platform for presenting the transmitted data.
